(19) United States
(12) Patent Application Publication
(10) Pub. No.: US 2007/0137503 A1
(43) Pub. Date: Jun. 21, 2007

(54) Pellet-fired smoke generator

(76) Inventors: Joseph P. Traeger, Mt. Angel, OR (US); Mark A. Traeger, Mt. Angel, OR (US); Randolph J. Traeger, Mt. Angel, OR (US); Brian E. Traeger, Mt. Angel, OR (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/303,405

(22) Filed: Dec. 16, 2005

(51) Int. Cl. A23B 4/03

(52) U.S. Cl. 99/482

(57) ABSTRACT

An apparatus for generating smoke is provided. The apparatus includes a hopper chamber that is adapted to receive pellet fuel and a smoke chamber that is adapted to collect and emit smoke. It also includes a pellet burning assembly with ends adjacent each chamber. The pellet burning assembly includes openings positioned to receive pellet fuel from within the hopper chamber and auger means for conveying pellet fuel from the openings to fire pots with perforated sides and a top communicating with the interior of the smoke chamber. The smoke chamber includes a baffle adapted to deflect sparks rising from the fire pots. The apparatus also includes one or more blowers adapted to supply air to the fire pot through the perforated sides of the fire pot.

### BACKGROUND

The present invention relates to pellet-fueled smoke generators that may be used in conjunction with so-called “smokers” or “smokehouses” in the preparation of food by smoking.

Pellet fuel has been recognized as an inexpensive and clean burning fuel with smoke that imparts the flavor of a wood-based fire to food. Such pellets are conventionally prepared by pelletizing comminuted wood waste under heat and pressure to produce a product of substantially uniform size. The use of solid pellets as a fuel source is known in the art of self-contained stoves and barbeques. For example, U.S. Pat. Nos. 4,823,684 and 6,223,737 describe barbeque devices that both smoke and cook food by the burning of pellet fuel.

Unlike stoves or barbeques, smoke generators do not include a means for supporting or storing the food to be prepared. Instead, smoke generators may be attached, as by tubing or piping, to a separate “smoker” or “smokehouse” unit with racks supporting the food to be smoked and/or cooked. Having separate devices for generating smoke and storing food allows for greater temperature adjustability and smoke purification. For instance, smoke in a self-contained stove or barbeque unit may reach the food at a temperature of 400° F. whereas smoke may enter a smokehouse from a smoke generator at 120 to 140° F., allowing for a wider range of applications. In the art of smoke generators, only fuel such as sawdust or charcoal is known, as can be found in U.S. Pat. Nos. 4,270,464 and 6,705,213. Charcoal is known to be an expensive fuel source, can be messy to handle, and requires significant time to ignite. Further, both charcoal and sawdust fuel are known to impart creosote chemicals, hydrocarbons, and other chemicals to the food being smoked or cooked, which may be unhealthy and can leave food with a bitter taste.

The present invention includes the burning of pellet-fuel in a separate, smoke generating device, allowing for the use of clean-burning and flavorful pellet fuel in a wide range of smoking applications. These and other objects and advantages are attained by the invention, which is described below.

### SUMMARY OF THE DISCLOSURE

An apparatus for generating smoke is provided. The apparatus includes a hopper chamber that is adapted to receive pellet fuel and a smoke chamber that is adapted to collect and emit smoke. It also includes a pellet burning assembly with ends adjacent each chamber. The pellet burning assembly includes openings positioned to receive pellet fuel from within the hopper chamber and auger means for conveying pellet fuel from the openings to fire pots with perforated sides and a top communicating with the interior of the smoke chamber. The smoke chamber includes a baffle adapted to deflect sparks rising from the fire pots. The apparatus also includes one or more blowers adapted to supply air to the fire pot through the perforated sides of the fire pot.

### BRIEF DESCRIPTION OF THE DRAWINGS

FIG. 1 is a schematic diagram of a first embodiment illustrating components of the pellet-fired smoke generator used in conjunction with a smokehouse unit.

FIG. 2 is a side perspective view of the embodiment in FIG. 1 with walls broken away to expose their interior components.

FIG. 3 is an enlarged, fragmentary perspective view of a lower portion of the embodiment of FIG. 2.

### DETAILED DESCRIPTION OF THE PREFERRED EMBODIMENT

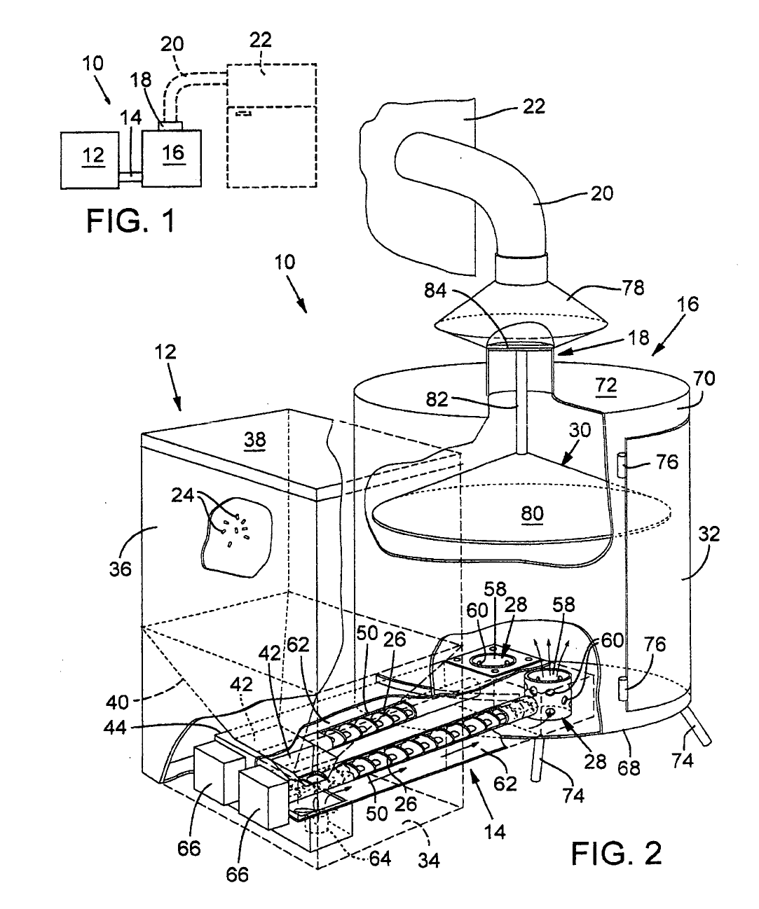

FIG. 1 diagrams some components of a pellet-fired smoke generator 10, when used in conjunction with a smokehouse unit 22. In this illustration, the pellet-fired smoke generator 10 may be comprised of a hopper chamber 12 which may receive and deposit pellets to a pellet burning assembly 14. Pellet burning assembly 14 may convey the pellets to a smoke chamber 16 where the pellets may be burned, producing smoke. The smoke may exit smoke chamber 16 through a smoke outlet 18, pass through a tube 20, and enter a smokehouse 22. Smokehouse 22 may contain food to be processed by the smoke created in the pellet-fired smoke generator.

FIG. 2 depicts an exemplary embodiment of a pellet-fired smoke generator 10, the smoke generator being designed according to the details of the present disclosure. In an illustrated embodiment, pellet-fired smoke generator 10 may include a hopper chamber 12 which may receive pellets 24. It may also include a smoke chamber 16. A pellet burning assembly 14 may span hopper chamber 12 and smoke chamber 16. Pellet burning assembly 14 may convey pellets from hopper chamber 12 to smoke chamber 16 by means of one or more augers 26. One or more fire pots 28 may burn pellets 24, creating smoke and sparks within smoke chamber 12. Smoke chamber 12 may include a spark baffle 30 having baffle member 80 which may deflect sparks arising from the burning of pellets 24 in fire pots 28. The smoke chamber may also include a door 32 and a smoke outlet 18.

As noted above, hopper chamber 12 may receive pellets 24 and deposit the pellets in pellet burning assembly 14. Hopper chamber 12 may be generally cubical and may have a floor 34, sides 36 and a top 38. Top 38 may act as an openable cover for depositing pellets 24 into hopper chamber 12. The hopper chamber may also contain funneling members 40 in the form of plates adjacent at one end to the interior sides 36 of hopper chamber 12. Funneling members 40 may be adapted to guide pellets 24 into one or more openings 42.

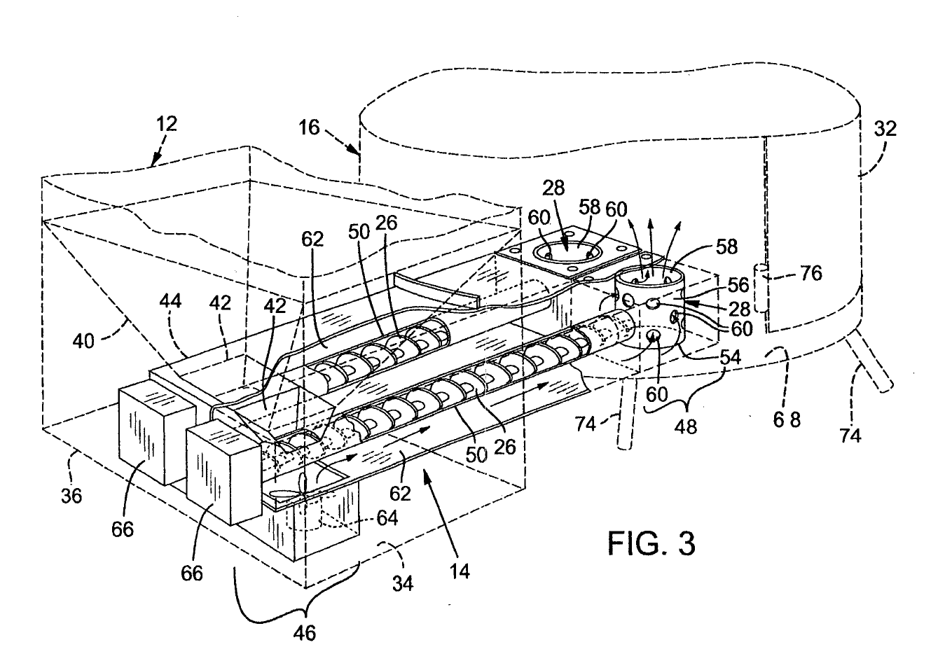

FIG. 3 depicts pellet burning assembly 14, which may include rectangular housing 44. Rectangular housing 44 may have a pellet entry end 46 that may be adjacent hopper chamber 12 and a pellet burning end 48 that may be adjacent smoke chamber 16. As used herein, “adjacent” may indicate that an item is either next to or inside of another item. Rectangular housing 44 may contain one or more generally horizontally extending auger tube assemblies 50. Each auger tube assembly 50 may contain an auger 26. At pellet entry end 46, auger tube assemblies 50 may share openings 42 to communicate with hopper chamber 12. At pellet burning end 48, auger tube assemblies 50 may be connected to fire pots 28.

Fire pots 28 may comprise cylinders with bottom 54, side 56 and an open top 58. Auger tube assemblies 50 may be connected to fire pots 28 through a circular opening in side 56. Through open top 58, fire pots 28 may communicate with the interior of smoke chamber 16. Side 56 may contain perforations 60. Fire pots 28 may also communicate with the lower interior 62 of rectangular housing 44 through perforations 60. Blowers 64 may be attached as by welding to rectangular housing 44 at a point approximately underneath openings 42. Blowers 64 may communicate with lower interior 62 and, accordingly, may communicate with fire pots 28 through perforations 60. Augers 26 may be powered by electric motors 66 which may be disposed at extreme pellet entry end 46 of rectangular housing 44.

As depicted in FIG. 2, smoke chamber 16 may be a cylinder with a floor 68, side 70, and top 72. Smoke chamber 16 may be supported by three or more legs 74. Side 70 may include a door 32. Attaching side 70 and door 32 may be one or more hinges 76. Top 72 may be closed to the atmosphere except as to smoke outlet 18. Smoke outlet 18 may be a hollow cylindrical form connected at the bottom as by welding to top 72. Vent hood 78 may be affixed to the top of smoke outlet 18 and may allow for the passage of smoke. Vent hood 78 may take in air from the atmosphere in addition to smoke from smoke chamber 16, but may prevent the escape of air or smoke to the atmosphere.

As noted, in the depicted embodiment, smoke chamber 16 also contains spark baffle 30 with baffle member 80. Baffle member 80 is supported by a support member 82 and a support bar 84. Baffle member 80 may be generally cone-shaped with the based disposed so that it is parallel to floor 68. Support bar 84 may be disposed across the diameter of the circular opening between smoke outlet 18 and vent hood 78. Support member 82 may be attached to support bar 84 and may extend downward to connect to the apex of baffle member 80 such that support member 84 is disposed perpendicularly to floor 68.

To begin operating the pellet-fired smoke generator, the door of the smoke chamber is opened and a small amount of pellets are placed in the fire pots along with combustible material such as paper. Next, the user turns on the blowers. The user then lights the pellets and combustible material in the fire pots, beginning combustion, and closes the door of the smoke chamber. To continue combustion, the cover of the hopper chamber is lifted and additional pellets are placed into the hopper chamber. The pellets are guided by funneling plates through the openings 42 and into the auger tubes. The user then activates the electric motors, which begin to turn the augers. The augers gradually convey the pellets through the auger tube and into the fire pots, where the pellets provide additional fuel for combustion.

To aid in combustion and the movement of smoke, the blowers push air along the lower interior of the pellet-burning assembly housing, through the perforations in the sides of the fire pots, and up into the smoke chamber, as indicated by the arrows in FIG. 2. Smoke generated by burning the pellets in the fire pots fills the smoke chamber and exits through the smoke outlet and, in turn, the vent hood. Sparks from the fire pots are deflected by the spark baffle. As noted above, a pellet-fired smoke generator as described herein may be connected as by a tube to a smokehouse unit having food to be prepared by smoking.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

What is claimed is:

1. An apparatus for generating smoke, the apparatus comprising:
a hopper chamber adapted to receive pellet fuel;
a smoke chamber having a floor, sides and a vented top, and including a baffle adapted to deflect sparks rising from a fire pot;
a pellet-burning assembly including an elongate housing with one end adjacent the hopper chamber and another end adjacent the smoke chamber, the elongate housing including:
an opening positioned to receive pellet fuel from within the hopper chamber;
the fire pot including perforated sides and a top communicating with the interior of the smoke chamber; and
auger means for conveying pellet fuel from the opening to the fire pot; and
a blower adapted to supply air to the fire pot through the perforated sides of the fire pot.

2. The apparatus for generating smoke of claim 1, wherein the top of the fire pot of the pellet-burning assembly is an open top.

3. The apparatus for generating smoke of claim 1, wherein the blower is supplying air to the fire pot through the elongate housing of the pellet-burning assembly.

4. The apparatus for generating smoke of claim 3, wherein the auger means is disposed in the elongate housing of the pellet-burning assembly.

5. The apparatus for generating smoke of claim 1, wherein the vented top of the smoke chamber comprises an outlet tube and a vent hood, the vent hood accepting air from the atmosphere in addition to air and smoke from the smoke chamber, and wherein the escape of air or smoke from the vent hood to the atmosphere is prevented.

6. An apparatus for generating smoke, the apparatus comprising:
a pellet-burning assembly including an elongate housing, the pellet-burning assembly including:
a tube disposed in the elongate housing having, at one end, an opening for the receipt of pellet fuel and, at the other end, a fire pot adapted to receive the tube;
the fire pot with perforated sides and an open top;
an auger disposed in the tube, the auger for conveying pellet fuel from the opening in the tube to the fire pot;
one or more motors adapted to power the augers; and
one or more blowers adapted to supply air to the fire pot through the perforated sides of the fire pot;
a hopper chamber adapted to contain pellet fuel with floor, sides and an openable cover, the hopper chamber including funneling means to guide pellets into the opening of the tube of the pellet-burning assembly; and
a smoke chamber adapted to collect and emit smoke, the smoke chamber having floor, sides and top, the smoke chamber also including:
a baffle adapted to deflect sparks rising from the fire pot of the pellet-burning assembly;
a door in the side of the smoke chamber; and
an outlet tube in the top of the smoke chamber permitting the escape of air and smoke.

7. The apparatus for generating smoke of claim 6, wherein the vented top of the smoke chamber includes a vent hood, the vent hood accepting air from the atmosphere in addition to air and smoke from the smoke chamber, and wherein the escape of air or smoke from the vent hood to the atmosphere is prevented.

8. A method for generating smoke by burning pellets, comprising the steps of:
selecting a hopper to contain pellets;
positioning an auger in an elongate enclosure;
positioning one end of the elongate enclosure adjacent the hopper;
positioning the other end of the elongate enclosure adjacent a chamber to collect and emit smoke generated by pellet-burning device;
loading the hopper with pellet fuel;
supplying pellet fuel by means of the auger to a fire pot adjacent the other end of the elongate enclosure;
lighting the pellet fuel to begin pellet combustion;
powering blowers to supply air to the fire pots to support combustion; and
intermittently supplying additional pellet fuel to the fire pots to continue the pellet combustion by rotating augers in the elongate enclosure.
